(19) United States
(12) Patent Application Publication
(10) Pub. No.: US 2002/0124953 A1
(43) Pub. Date: Sep. 12, 2002

(54) Non-woven elastic microporous membranes

(76) Inventors: Michael S. Sennett, Sudbury, MA (US); Heidi L. Schreuder-Gibson, Holliston, MA (US); Phillip W. Gibson, Holliston, MA (US); Kris J. Senecal, North Smithfield, RI (US)

Correspondence Address: Patent Counsel, U.S. Army Soldier and Biological Chemical Command, 15 Kansas Street, Natick, MA, 01760-5035, US

(21) Appl. No.: 10/097,876

(22) Filed: Mar. 14, 2002

Related U.S. Application Data
(62) Division of application No. 09/413,703, filed on Oct. 6, 1999.

(51) Int. Cl. B44C 1/00

(52) U.S. Cl. 156/273.1; 156/63

(57) ABSTRACT

A breathable net-shape microporous membrane structure is created by forming a polymeric solution and electrostatically spinning polymeric fibers from the solution into a microporous membrane structure. The average fiber size ranges from about 0.1 microns to about 1 micron and the average pore size ranges from about 0.4 to about 3.0 microns.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND OF THE INVENTION

1. Field of the Invention

The present invention relates to microporous membranes composed of small-diameter elastic fibers disposed in a random non-woven orientation having an effective pore size for water vapor passage, while prohibiting liquid water passage. More particularly, the method and product of the present invention include net-shape microporous membranes structures that impart wind resistance to protective garments, without impeding breathability. The microporous membranes are useful in outdoor clothing, temporary tent shelters and other similar permeable devices.

2. Brief Description of the Related Art

Over the past twenty years there has been a steady growth in the applications of microporous polymeric fabrics in clothing for protection from the elements. An example of these is Gore-Tex®, which is microporous expanded PTFE, i.e., Teflon®. Although textile systems incorporating expanded PTFE are effective at providing protection from the elements, such materials are non-elastic, stiff, heavy and increasingly inflexible as surrounding temperatures are decreased. Textile systems incorporating expanded PTFE are relatively expensive, restricting the application of expanded PTFE to smaller and high value items. The expanded PTFE membranes are fabricated in flat sheets, necessitating extensive processing, e.g., cutting and seaming, when the expanded PTFE is incorporated into garments or other geometrically complex structures.

Several types of fiber structures have been disclosed. U.S. Pat. No. 3,783,093 to Gallacher discloses fibrous polyethylene materials having a fibrillated structure containing interconnected ribbons with the thickness of the ribbon-like elements ranging from about 0.3 to about 20 microns. U.S. Pat. No. 3,841,953 to Lohkamp et al. discloses nonwoven mats of thermoplastic blends by melt blowing having fibers with diameters of 0.5 to 50 microns having a blend of at least two or more thermoplastic resins. U.S. Pat. No. 4,041,203 to Brock et al. discloses a nonwoven thermoplastic fabric having continuous and randomly deposited filaments having a diameter in excess of 12 microns that is integrated with a mat of generally discontinuous, thermoplastic microfibers of up to about 10 microns. U.S. Pat. No. 4,107,364 to Sisson discloses a randomly laid bonded continuous filament cloth that has at least two types of filaments, one of which being relatively elastomeric. U.S. Pat. No. 4,524,036 to Gilding et al. discloses a manufacturing process for the production of a polyurethane resin capable of being electrospun. U.S. Pat. No. 4,618,524 to Groitzsch et al. discloses a microporous multilayer nonwoven material having a layer of nonwoven, microfiber material with fiber diameters of 0.1 to 10 microns, attached to nonwoven layers covering opposite sides, having water-repellent paste members penetrating through and bonding the layers. U.S. Pat. No. 4,741,949 to Morman et al. discloses an absorbent nonwoven elastic material formed by meltblowing fibers composed of polyetherester. Meltblown fibers are formed by extruding a molten thermoplastic material through a plurality of fine die capillaries as molten filaments into a high velocity gas, which are then deposited on a collecting surface to form a web of randomly disbursed meltblown microfibers. U.S. Pat. No. 4,774,125 to McAmish discloses a melt-blown microfabric, with at least one surface veneer and a core web. The surface veneer has an average fiber diameter of greater than 8 microns. In McAmish, a surface abrasion resistance is achieved with the addition of a surface veneer of melt-blown fibers, that may be bonded to a melt-blown core web. U.S. Pat. No. 5,695,849 to Shawver et al. discloses an elastic, breathable barrier fabric useful in diaper, training pants, and other articles used to contain bodily fluids with an average microfiber diameter not greater than about 75 microns.

U.S. Pat. No. 4,143,196 to Simm et al. discloses a process for electrostatically spinning fibers of less than 1 μm thickness continuously onto a moving web of filter media. U.S. Pat. No. 4,043,331 to Martin et al. discloses an electrostatic spinning process to prepare a multilayered material for wound dressings containing immobilized ingredients on microfiber surfaces. Both of these patents are directed to processes for either air filtration or medical wound dressing production, and are unsuitable for textile applications.

Although microporous fiber compositions are known, there remains a need in the art for a simplified process to form microporous compositions to specific forms. The present invention addresses this need.

### SUMMARY OF THE INVENTION

The present invention includes a breathable microporous membrane product formed into a net-shape layer from the process comprising the steps of forming a polymeric solution, and electrostatically spinning microporous membranes of polymeric fibers from the solution into a microporous membrane product, wherein the average fiber size ranges from about 0.1 microns to about 1 micron and the average pore size ranges from about 0.4 to about 3.0 microns.

The present invention further includes a method for forming a microporous membrane structure comprising the steps of forming a polymeric solution, and electrostatically spinning fibers into a net-shape structure.

Additionally, the present invention includes a microporous membrane net-shape structure comprising an average fiber size ranging from about 0.1 microns to about 1 micron and an average pore size ranging from about 0.4 to about 3.0 microns.

The present invention is particularly applicable for incorporating inclusion products within the microporous membrane structure. The microporous membrane may possess physical characteristics of improved moisture vapor diffusion resistance, elasticity, airflow resistance and tensile strength. The microporous membrane structure is formed from the single or multiple step electrostatic spinning into a pre-determined form by directly spraying the membrane-forming fibers onto a flat moving fabric surface or spraying the membrane directly onto a curved, three-dimensional surface to comprise net-shape manufacturing.

### BRIEF DESCRIPTION OF THE DRAWINGS

FIG. 1 illustrates a one-step process for electrostatically spinning a breathable elastomeric microporous membrane onto a net-shape headform;

FIG. 2 is a photograph of the microporous membrane as formed by the process shown in FIG. 1 using a flat grounded wire screen in place of the headform to collect electrospun fiber;

FIG. 3 is a photograph of the microporous membrane with encapsulated materials as formed by the process described in FIG. 2; and,

FIG. 4 is a photograph of the microporous membrane with embedded materials as formed by the process described in FIG. 2 using a stream of air borne solid particles directed into the nanofiber spray of FIG. 1.

### DETAILED DESCRIPTION OF THE PREFERRED EMBODIMENT

The present invention comprises a family of microporous membrane structures composed of small-diameter elastic fibers disposed in a random non-woven orientation having an effective pore size such that water vapor can pass through it but liquid water cannot. The structures further have the property of being resistant to air flow, known as wind resistance, in protective garments. The structures may be used singularly, or in combination with other layer materials, particularly fabrics. The structures of the present invention are useful as components within clothing, especially for outdoor wear. As such, clothing that incorporates the structures of the present invention are “breathable”, allowing water vapor from the wearer's body to escape while preventing rain and/or wind from penetrating the clothing. Similarly, the structures of the present invention also are useful as components of flexible outdoor gear, such as temporary shelters, tents, furniture covering and/or other like devices requiring membranes with selective permeability. Particularly applicable are military uses of the present invention that include the membranes being used for military clothing and shelters and for skin protection against certain types of chemical warfare agents, such as toxic aerosols. Such membrane structures can be produced by either a continuous fabric coating operation, by sequential fabric laminating methods, or by directly spraying the fibrous membrane onto a curved, three-dimensional surface to produce a final formed shape in one step.

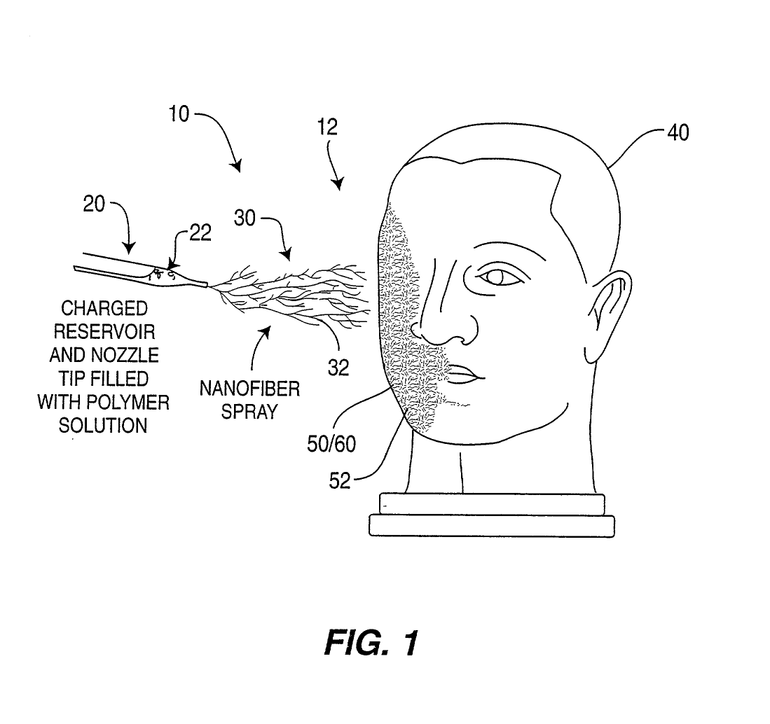

Referring to FIG. 1, the structures 10 of the present invention comprises a net-shape construction 12. As seen in FIG. 1, a charged reservoir and nozzle tip 20 containing an appropriate polymer solution 22 is used to electrostatically spin 30 nanofiber, i.e., fiber thickness less than 1 μm, elements 32 onto a pre-determined shape 40, such as the headform shown in FIG. 1. With contact of the nanofiber elements 32 onto the headform 40, the nanofiber elements 32 form a microporous membrane layer 50 attached to the headform 40. The formed microporous membrane layer 50 makes an article 60 of manufacture by the net-shape process 12 which can be subsequently removed from the headform 40 and reinforced, if necessary, to form a breathable skin mask in this particular example.

Net-shape manufacturing equipment 10 of the formed structures 12 includes a grounded, conductive pre-formed base design or figure that collects the charged nanofiber elements 32 being applied through electrostatic spinning 30. The pre-formed base may include single-layer/plane structures, three-dimensional forms, such as curved structures, body forms, or other like formats, on which the microporous membranes 52 adhere, causing the formed microporous membrane layer 50 to conform to particular pre-determined shapes. The application of the microporous membrane layer 50 may include a single layer application of the microporous membranes 52, or multiple layers/applications of the microporous membranes 52 in different layers having differing properties. Within individual articles 60, different sections of the same article 60 may comprise different thicknesses of microporous membranes 52, as appropriate. For example, a first application of microporous membranes 52 may be applied with various thicknesses at different parts of the structure 12. A second application of a different composition of microporous membranes 52 may then be selectively applied onto the first application of microporous membranes 52 to impart different characteristics among different parts of the article 60.

Electrostatic spinning 30 the microporous membranes 52 may be accomplished by spraying fibers within a selected area of high voltage application, where the fibers are attracted or repulsed int a collection zone by a high voltage electrostatic field contained therein. The thickness of the microporous membrane layer 50 of the structure 10 may be controlled by varying the electrostatic spinning 30 parameters, such as the solid content of the polymer solution, target distance, emitter speed, pressures, angles, electric field strength and other such parameters. Movement of the net-shape/mandrel may also be set a pre-determined values. Electrostatic spinning processes have been described in U.S. Pat. No. 4,043,331 to Martin et al. and U.S. Pat. No. 4,143,196 to Simm et al., the disclosures of which are herein incorporated by reference.

The present invention may be produced using a wide range of elastic materials that are formable into extremely small, submicron diameter fibers. These fibers are continuously deposited during the electrostatic spinning 30 in a random orientation to form a continuous mat or microporous membrane layer 50 with a controlled porosity that is determined by the average diameter and spacing of the fibers. The polymeric solution 22 may comprise various types of compositions, ranging in appropriate solution content to impart the desired characteristics into the structure 12, preferably as a polymer resin suitable for deposition onto a predetermined shape 40 through electrostatic spinning 30. Examples of the polymer resin within the polymer solution 22 include, without limitation, polyurethanes such as Dow Chemical's Pellethane®, BF Goodrich's Estane® and other thermoplastic elastomers or TPE's such as Shell's Kraton®. Additional additives may be incorporated into the polymeric solution 22 for a given purpose, with the amount and type of additional additive determinable by those skilled in the art. For example, the degree of porosity of the microporous membrane layer 50 may be varied with the addition of various amounts of non-solvents incorporated into the polymeric solution 22.

The electrostatic spinning 30 is preferably performed using a charged reservoir, pipette, or needle 20 containing an appropriate polymer solution 22. As the nanofiber elements 32 exit the charged reservoir tip 20 onto the predetermined shape 40, the thickness may be calibrated through known factors in the art, such as the amount of charge, concentration of the polymeric solution 22, distance, angle, and other like factors. The type nanofiber elements 32 exiting the charged reservoir tip 20 is determinable with the type of polymer resin component of the polymeric solution 22. With the completion of a first microporous membrane layer 50, the same or a different charged reservoir 20 may be used to form a second microporous membrane layer 50 of a different type than the first microporous membrane layer 50.

Application of the microporous membrane layer 50 generally includes spraying the nanofiber elements 32 onto the pre-determined shape 40, which constitutes a charged surface. The spraying may comprise a single process step, or may be augmented by numerous spray steps. Single spray formation of the present invention includes electrostatically depositing an initial base of microporous membrane 52 material onto the pre-determined structure 40, which may constitute an intermediate or final article 60.

When the initial base comprises an intermediate article 60 of manufacture, a second microporous membrane layer 50 is formed. After the application of a single or base layer, the second direct spray application may cover the complete area of the first microporous membrane layer 50, or may include only portions of the first microporous membrane layer 50 area already covered. In situations where the first microporous membrane layer 50 covers the complete body, the second and other additional layers into the structure 12 may be used to reinforce areas of the first microporous membrane layer 50. This includes the application of the same or similar microporous membranes 52 having structural components to increase the thickness and/or strength of the first microporous membrane layer 50. The additional layers may also comprise microporous membrane layers 50 that are different from the first microporous membrane layer 50 to impart distinct characteristics into the formed structure. Different elastomeric materials may be used to create the fibrous structure with the inclusion of various compounds during the formation of the fibers, through encapsulation within the fiber or through commingling of the secondary component effecting entanglement or embedment with the fiber, or through post spinning imbibing resins or other continuous phases into the pore structure to impart properties to the membrane such as color, odor, chemical reactivity, selectivity against vapor and liquid permeates or electrical conductivity, i.e., to prevent the buildup of electrostatic charge on clothing or other textile systems.

Manufactured articles 60 formed from the present invention are capable of conforming to predetermined sizes and shapes without the need for cutting or sewing. The articles 60 are electrostatically produced in the correct dimensions and thicknesses for a given purpose. These may include three-dimensional structures such as body suits, gloves, boots, hats, etc., that are processed into particular sizes, and/or for particular persons. As the microporous membranes 52 are sprayed and layered into predetermined forms, the need for further processing, such as cutting, sewing, etc. is eliminated.

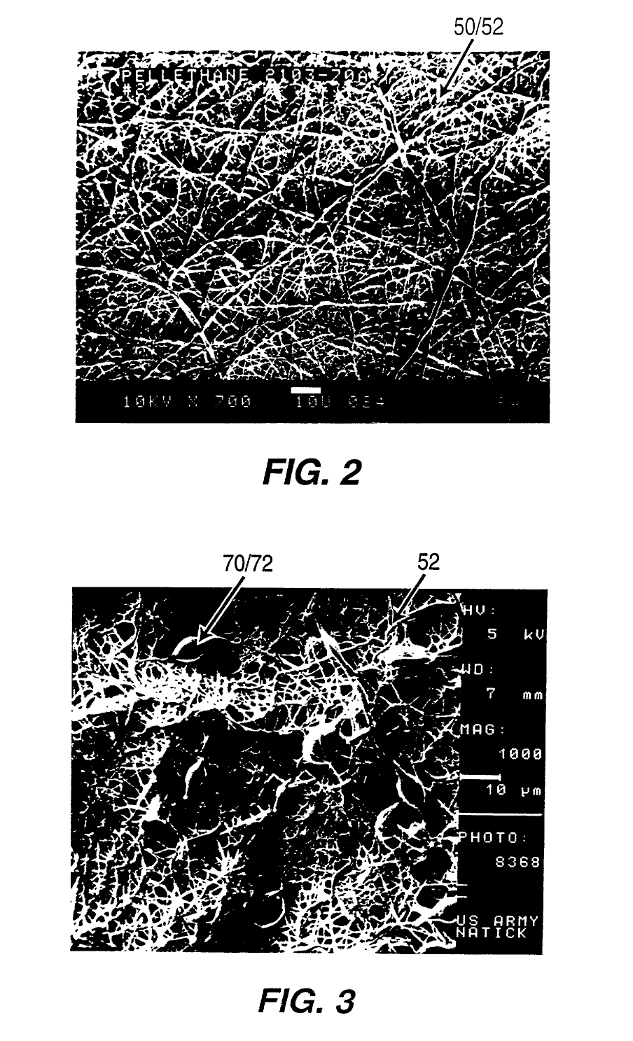

As seen in FIG. 2, the microporous membrane layer 50 comprises numerous microporous membranes 52. The microporous membranes 52 may be applied directly to textiles, woven or non-woven, or without a textile base with the microporous membrane layer 50 being self-supporting, i.e., able to structurally maintain itself without other bracing members. When used directly on textiles, the microporous membranes 52 may be applied with or without the use of additional adhesives to form a composite laminate with the textile. Incorporation of additional components with the microporous membranes 52 is dependant on the desired properties of the final structure 12, with the type and amount of additionally components determinable by those skilled in the art in accordance with the disclosure herein.

Articles 60 comprising the breathable microporous membranes 52 of the present invention may be widely varied in construction and composition. Within the construction of the articles 60, the net-shape process 10 may include a single step process, double step process, and/or multiple steps in the process of forming the net-shape 12 microporous membrane layer 50.

The composition of the articles 60 may possess a wide variety of beneficial characteristics. For permissible clothing manufacture, articles 60 of the present invention are formed with the microporous membranes 52 have an average fiber size of from about 0.1 micron to about 1 micron, and an average pore size of from about 0.4 micron to about 3.0 micron. This permits the articles 60 to possess applicable characteristics of breathability. The average fibers diameter and spacing control the average effective pore diameter in the formed articles 60, with the fiber forming conditions being variable to produce fibers of the appropriate size range for the porosity desired. In the preferred method of producing the microporous membranes 52 by electrostatically spinning fibers from solution directly onto a three-dimensional substrate 40, as the spinning and spraying occur simultaneously, the fibers deposit and bond together to produce a tough, elastic and microporous continuous membrane. If the three-dimensional substrate 40 is not coated with an adhesion resistant surface treatment, the microporous membrane layer 50 may be sprayed directly onto and bonded tenaciously to the three-dimensional substrate 40 to make a composite laminate. Alternatively, the membrane can be co-processed with a bondable, adhesive spray or fusible fiber in the electrostatic spinning 30 apparatus to impart bondability to the microporous membranes 52.

In one preferred embodiment, the microporous membranes 52 are sprayed onto a pre-determined form 40 substrate in an uneven fashion to build different properties within different areas of the same article 60. For example, formed articles 60 of clothing may incorporate microporous membrane layers of different thickness into different parts of the clothing to optimize wear. Thinner layers may be included around the chest area, with thicker layers incorporated into high-wear areas, such as knees and elbows. Density of the layers may also be varied to optimize performance, such as formed layers of microporous membranes 52 having less density at high perspiration locations or more density at high abrasion locations. Key areas of garments may be protected with the application of different fibers with desired properties to enhance toughness, abrasion, elasticity or breathability.

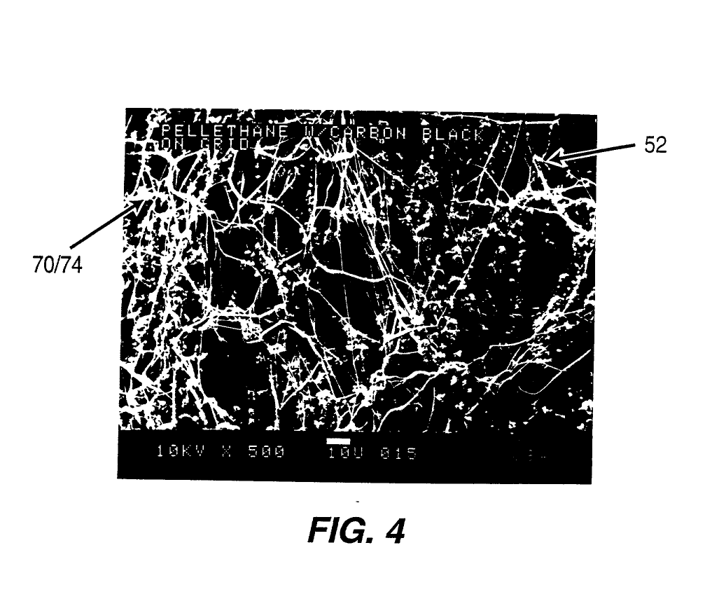

Other preferred embodiments of the present invention, as seen in FIGS. 3 and 4, include the inclusion of additive components 70 within the structure that are particularly useful for a given purpose. These additives 70 may include mechanical features, solid additives, reactive compounds and/or fusible components. Additives 70 are selected for a given purpose within the structure and may be included in amount and forms that permit the optimum performance of the desired characteristics. As such, additives 70 may be incorporated into the structure as wires, sensors, fine particles, thermally activated adhesives and/or other dispersions that maximize their beneficial effect to the formed article structure 60.

Mechanical devices may be incorporated within the article 60 during net shape manufacturing 10. Mechanical devices include such features as support areas, mechanical applicators and/or devices, holding areas, reinforced openings, wires, and/or other physical structures that alter the design of the formed structure to a specific purpose. For example, support areas may be used to form foot placements in shoes. Mechanical applicators such as thermometers may be held in place for detecting heat exhaustion/stroke and/or heart rate, with appropriate alarms incorporated therein when desired. Likewise, pin holders, pockets, button-holes and other like items may be placed into the structure of the microporous membrane layer 52. “Active” types of mechanical apparatus also may be incorporated within articles 60 of the present invention, such as “cool-down” or “warm-up” aids for persons engaging in sporting activities or in need of medical assistance.

As seen in FIG. 3, additional components may be incorporated in the process by placing inclusion materials into the polymeric solution 22 prior to the electrostatic spinning 30, or by embedding the inclusion materials by a second air stream of particles directed into the nanofiber spray 30 to produce microporous membranes 52, as seen in FIG. 4. Solid additives include such materials as reactive compounds, e.g., solid catalysts, sorptive compounds, e.g., silica, talc, clay and carbon black; metals for electrostatic protection, phase change materials, and wicking compounds, e.g., short fibers. Non-solid additives include secondary components such as fusible polymers and adhesives, reactive compounds, e.g., bactericide, enzymes, drugs, and catalysts that can dissolve into the polymer solution 22 prior to electrostatic spinning 30.

Reactive compounds are used to alter the chemical/medicinal environment in areas of the formed article 60. Bactericide chemically inhibit the growth of bacteria on the formed microporous membranes 52. Sorptive ingredients, such as carbon black, increase the ability of the microporous membrane 52 to absorb contaminating vapors into the formed article 60. Short wicking fibers impart the ability to transport liquids, such as water, across the membrane. Inclusion of reactive compounds within the electrospun fibers impart reactive properties to the microporous membranes 52 of the formed article 60. These reactive properties may include enabling the microporous membranes 52 to absorb an undesirable toxic substance and break it down into a harmless compound. The reactive compounds may be either encapsulated or embedded with the microporous membrane structure.

As further seen in FIG. 3, encapsulation of the reactive compounds 72 into the individual fibers of the microporous membrane 52 is accomplished by dissolving the reactive compound into the polymer solution prior to electrostatic spinning to form the microporous membrane 52. The reactive compound is thus encapsulated within the fiber and surrounded by a fine polymer layer. After diffusion of a contaminating vapor or liquid through the microporous membrane 52 fiber surface to the encapsulated active ingredient 72, a reaction to transform the liquid or vapor molecules proceeds at the reactive site within the fiber.

Embedment 74, as seen in FIG. 4, of the reactive or absorptive compounds is achieved by entangling the solid compound with the submicron fiber of the membrane. Compounds attach to and amass on the outside of the fibers. This is accomplished by introducing two separate streams of material into the formation of the microporous membranes 52, with one stream containing the reactive compound in solid form or dissolved within liquid droplets and the other stream 22 containing the electrostatically charged polymer fiber. Through this co-processing, the reactive compound becomes bound into the membrane by physical anchoring or forms only a surface bond on the outside surface of the fibers. The reactive material becomes anchored within the structure of the microporous membrane 52 mat, but is not encased within the structure of the individual microporous membrane 52 fibers. Co-processing may be advantageously used to alter the concentration of secondary, reactive compounds in a single area, or in groups of areas. In a comparison of the difference between encapsulated and embedded structures, encapsulated bactericide are able to inhibit the growth of bacteria within the microporous membrane 52 fiber through diffusion of water and bacteria into the microporous membrane 52 fiber, with concentrations of the bactericide alterable by using fibers with higher levels of bactericide in specific areas of a membrane. Within an embedded compound, such as absorbent carbon black, the carbon black is held in place in the microporous membrane 52 by physical entrapment forces. This provides a greater amount of surface area available to quickly absorb vapors as they pass through the microporous membrane 52, unimpeded by any encapsulating layers of polymer. However, if the high concentration of the embedded material tends to weaken the microporous membrane 52, thick layers of higher strength fiber layers can be processed into the microporous membrane 52 structure to reinforce the microporous membrane layer 50 at desired locations.

When reactive compounds are embedded into the microporous membrane layer 50 by surrounding fibers, the reactive compound is present as a separate component within the pores of the microporous membrane 52, not part of the fiber core. Embedded compounds have a larger surface area exposed to the open environment, allowing a greater rate of diffusion into the surrounding area. This provides greater concentrations of reactive compounds that are available to alter the local environment of the embedded compounds, as compared to the limited concentrations of encapsulated compounds.

Fusible components, such as adhesives, may be obtained from commercial sources and added to the microporous membrane layer 50 during electrostatic spinning 30 formation of the microporous membranes 52. The fusible components may be electrostatically formed into discrete bondable microfibers which are intermingled within the microporous membrane 52 structure or may be bondable non-fibrous droplets formed from either electrostatic or pressurized spray atomization techniques during microporous membrane 52 formation. Such fibers or droplets are subsequently heated or moisture cured to impart strength to a bond between elements within and/or between the microporous membrane layers 50 and a chosen substrate, or to increase the cohesive strength within and/or between the microporous membrane layers 50.

The microporous membranes 52 of the present invention further provide sufficient resistance to moisture vapor diffusion and provide minimal resistance to the process of evaporative cooling through perspiration. Preferably, the moisture vapor diffusion resistance of the present invention ranges from about 40 s/m to about 2,000 s/m, more preferably from about 50 s/m to about 250 s/m, and most preferably from about 60 s/m to about 150 s/m.

Elasticity of formed microporous membrane layers 50 impacts on the use of articles 60 formed from the electrostatic spinning 30, and enables the microporous membranes 52 to be directly sprayed onto stretchable fabrics, such as knits. As such, the microporous membranes 52 of the present invention preferably possess sufficient elasticity to form products capable of outdoor personal use and/or other uses requiring outdoor durability. Preferably, the articles 60 of the present invention possess an elasticity in the range of from about 200% to about 700%, and more preferably from about 400% to about 600%.

Another embodiment of the present invention includes the incorporation of thermally fusible microfibers or microlayers as well as bondable droplets into the membranes to simplify fabrication steps in complex shapes and laminates.

Another embodiment includes the combination of more than one functional microfiber layer into the fibrous membrane for added protective features such as increased water repellency, decreased flammability, anti-bacterial or anti-fungal properties.

Preferably, microporous membrane layers 50 of the present invention also possess sufficient tensile strength for outdoor wear when used in personal articles. The tensile strength preferably ranges from about 100 psi to about 50,000 psi, more preferably from about 100 psi to about 5,000 psi.

The airflow resistance of the microporous membrane layers 50 of the present invention preferably ranges from about 3×10⁸ m⁻¹ to about 10¹⁰ m⁻¹. This airflow resistance provides manufactured articles 60 with a degree of wind protection suitable for outdoor wear.

The microporous membranes 52 of the present invention is useful in various articles 60 of manufacture, such as clothing and clothing accessories with particular applicability to outdoor wear. Clothing accessories may include, without limitation, gloves, socks, boots and/or other accessories known in the art. Additionally, other types of outdoor articles also may incorporate the microporous membrane 52 of the present invention, such as tents, tarpaulins, hammocks, furniture coverings and/or other outdoor uses determinable by those skilled in the art.

One particularly useful embodiment of the microporous membrane 52 comprises the use of the net-shape microporous membrane structure as a filtration medium. Multiple layers of filtration, as well as various densities, may be used to address particular water or other filtration requirements for a given region/locality or purpose. This may include layering of general filters with specialty filter-layers of electrospun combinations of absorptive and self-decontaminating fibers for purification of water supplies to remove a particular waterborne hazard, such as a parasite or other contaminant that the general filters were designed to remove. Different specialty filters may be used with fuel purification directed to specific contaminants through the incorporation of appropriate additive compounds, shown in FIGS. 3 and 4.

Another useful embodiment of the microporous membrane 52 formed by electrostatic spraying 30 comprises the use of the microporosity and elasticity for use as an automobile airbag, exhibiting controlled gas pressurization flow rates as a function of porosity and deformability. The shape of the airbag can be produced without seams by the net-shape processing advantages afforded by the electrostatic spinning procedure. Such a shape can be manufactured into a metal mandrel, followed by the electrostatic spinning step to produce a controlled porosity microporous membrane 52 upon the mandrel surface, followed by removal of the article 60 from the mandrel.

Advantages of the microporous membranes 52 of the present invention in comparison to expanded PTFE membranes include lighter weight, increased flexibility and elasticity, lower cost, increased ease of addition of secondary components, increased ease of manufacture and increased ease of fabrication into garment systems and other complex shapes.

### EXAMPLE 1

Various thermoplastic elastomeric polymers were dissolved into mixed organic solvents to solution compositions of 5-10% by weight polymer. Solvent mixtures were adjusted to maintain constant solution spraying during electrostatic spinning. This was accomplished by adding 10% ethanol to methylene chloride solvent to enhance spinning characteristics. A reservoir of solution was charged to at least 5,000 volts using low current (100 μA) from commercially available power supplies. The formed polymer spray was made of fibers as disclosed in U.S. Pat. No. 1,975,504 to Formhals, U.S. Pat. No. 4,143,196 to Simm et al. and U.S. Pat. No. 4,043,331 to Martin et al., the disclosures of which are herein incorporated by reference. The fibers were collected on various substrates, including fabrics, sheet foam, nonwoven battings, and three dimensional objects with complex shapes held at a distance of 10-20 cm. The final form of the electrostatic spun fiber mat was characterized by a high degree of fiber consolidation, resulting in good membrane tensile strength, small fiber size, fine pore size, high transport of vapors, high air resistance, high tensile strength, moderate modulus, and exceptional elongation. Solvent cast film and electrospun membranes of Pellethane® and Estane® supplied by DOW and B F Goodrich, respectively, are listed in Table 1, below.

TABLE 1
Membrane Characterization/Tensile Properties (50%/min strain rate)

| SAMPLE* | Modulus (Mpa) | Stress (Mpa) | Strain (%) |
|---|---|---|---|
| Pellethane ® (Lot 1) Film | 1.4 | 1.0 | 278 |
| Electrospun Pellethane ® (Lot 1) | 0.93 | 1.4 | 178 |
| Electrospun Pellethane ® (Lot 2) | 7.7 | 5.5 | 298 |
| Electrospun Estane ® (Lot 1) | 5.2 | 2.7 | 443 |

*Density of Electrospun Membrane: 60% fiber with overall 0.66 g/cc density.

The foregoing summary, description, example and drawings of the present invention are not intended to be limiting, but are only exemplary of the inventive features which are defined in the claims.

What is claimed is:

1. A breathable microporous membrane product formed into a net-shaped layer from the process comprising the steps of:
forming a polymeric solution; and,
electrostatically spinning microporous membranes of polymeric fibers from the solution into a microporous membrane product, wherein the average fiber size ranges from about 0.1 microns to about 1 micron and the average pore size ranges from about 0.4 to about 3.0 microns.

2. The membrane structure product of claim 1, wherein the product moisture vapor diffusion resistance ranges from about 40 s/m to about 250 s/m.

3. The membrane structure product of claim 1, wherein the product vapor diffusion resistance ranges from about 60 s/m to about 150 s/m.

4. The microporous membrane product of claim 1, wherein the product elasticity ranges from about 200% to about 700%.

5. The microporous membrane product of claim 4, wherein the product elasticity ranges from about 300% to about 500%.

6. The microporous membrane product of claim 1, wherein the product tensile strength ranges from about 100 psi to about 5,000 psi.

7. The microporous membrane product of claim 1, wherein the product airflow resistance ranges from about 3 times 10⁸ m⁻¹ to about 10¹⁰ m⁻¹.

8. The microporous membrane product of claim 1, wherein the product geometry conforms to a desired shape.

9. The microporous membrane product of claim 8, wherein the product geometry conforms to a desired shape in a one-step direct spray application.

10. The microporous membrane product of claim 9, further comprising at least a second direct spray application capable of varying thickness and composition from region to region.

11. The microporous membrane product of claim 1, further comprises additive inclusion within the product.

12. The microporous membrane product of claim 11, wherein the additives are selected from the group consisting of solid additives, reactive compounds and fusible components.

13. The microporous membrane product of claim 12, wherein the reactive compounds are selected from the group consisting of bactericide, decontamination reaction catalyst, enzymes, crosslinking agents, sorptive ingredients and short wicking fibers.

14. The microporous membrane product of claim 12, wherein the reactive compounds are encapsulated with the forming fibers.

15. The microporous membrane product of claim 12, wherein the reactive compounds are entangled with the forming fibers and embedded in the microporous membranes.

16. The microporous membrane product of claim 1, wherein the product composition and thickness are varied to build different properties within different areas of the structure.

17. The microporous membrane product of claim 1, wherein the product comprises an article of manufacture selected from the group consisting of clothing, tents, gloves, socks, and boots.

18. The microporous membrane product of claim 1, wherein the product comprises a filtration medium.

19. The microporous membrane product of claim 1, wherein the product comprises a controlled flow airbag.

20. A method for forming a microporous membrane net-shape structure comprising the steps of:
forming a polymeric solution; and,
electrostatically spinning polymeric fibers from the solution into a microporous membrane structure.

21. The method of claim 18, wherein the step of electrostatically spinning fibers incorporates inclusion products within the structure selected from the group consisting of solid additives, reactive compounds and fusible components.

22. A microporous membrane net-shape structure comprising an average fiber size ranging from about 0.1 microns to about 1 micron and an average pore size ranging from about 0.4 to about 3.0 microns.

23. The microporous membrane structure of claim 21, further comprising:
a moisture vapor diffusion resistance of from about 40 m/s to about 200 m/s;
an elasticity of from about 200% to about 700%;
an airflow resistance ranging from 3 times 10⁸ m⁻¹ to about 10¹⁰ m⁻¹; and,
a tensile strength of from about 100 to about 5,000 psi.
